(19) United States
(12) Patent Application Publication
(10) Pub. No.: US 2018/0236274 A1
(43) Pub. Date: Aug. 23, 2018

(54) RETRIEVAL TOWER AND RESCUE METHOD FOR SLOPED ROOF STRUCTURES

(71) Applicant: Jeffrey D. Decker, Lerna, IL (US)

(72) Inventor: Jeffrey D. Decker, Lerna, IL (US)

(21) Appl. No.: 15/900,087

(22) Filed: Feb. 20, 2018

Related U.S. Application Data
(60) Provisional application No. 62/461,935, filed on Feb. 22, 2017.

(51) Int. Cl. A62B 1/06

(52) U.S. Cl. CPC A62B 1/06

(57) ABSTRACT

A retrieval tower for rescuing a person from within a grain bin or other storage structure having a sloped roof is disclosed. The tower comprises a base surrounding an opening in the roof. The base includes a clamp member insertable into the opening under a portion of the base so as to clamp a portion of the roof between the clamp member and base. A pair of spaced legs is attached to the base, and a head is supported by the upper ends of the pair of legs. At least one other leg extends down from the head and is attached to the base. The tower is movable from a first position in which a rescue rope will extend down from the head into the opening to a second position in which the rope is clear of the edge of the roof.

### CROSS-REFERENCE TO RELATED APPLICATIONS

This application claims the benefit of U.S. Provisional Application No. 62/461,935, filed Feb. 22, 2017, the disclosure of which is hereby incorporated by reference in its entirety.

### STATEMENT REGARDING FEDERALLY SPONSORED RESEARCH OR DEVELOPMENT

Not Applicable.

### BACKGROUND OF THE DISCLOSURE

This disclosure relates to a retrieval tower that can be readily erected on a sloped (or on a flat) roof of a grain bin or other storage structure over an opening in the roof such that rescue ropes or a winch and cable may be attached or mounted to the tower over the opening so that rescue team members can be lowered into the storage structure and so that a person entrapped in grain or the like or otherwise incapacitated in the storage structure may be retrieved.

Grain bins, tower dryers, silos and other structures hold large quantities of fluent, granular material, such as grain (e.g., corn, soy beans, wheat, or the like) or other fluent products, such as plastic pellets. In addition, such storage structures include petroleum tanks and the like. Grain stored within such storage structures is often unloaded by means of an unloading conveyor (e.g., an auger conveyor) located at the bottom of the storage structure. Upon actuation of the unloading conveyor, grain or other fluent, granular material will be unloaded from the bottom of the storage structure. As grain is unloaded from the bottom of the storage structure, grain in the storage structure will flow in a conical-shaped column of grain moving downwardly toward the unloading conveyor. At times, a farmer or grain handling personnel will enter the storage structure and walk on the top surface of the grain to inspect the grain or to break up grain bridges or the like that inhibit the downward flow of grain toward the auger or conveyor. If the unloading conveyor is turned on to unload grain while a person is walking on the top surface of the grain, the downward flow of grain will entrap the person's feet and legs. Once a person's legs become entrapped, the weight of the grain around the legs prevents the person from moving. If the unloading conveyor is not turned off, the person will continue to sink into the grain until the person is buried in the grain, which often leads to suffocation and death. Many persons will think that they can escape from the moving grain column by climbing up out of the grain, but entrapment can happen quite quickly, within about 10 seconds or so, depending on the type of grain, the unloading capacity of the unloading conveyor, the diameter of the grain storage structure, and the depth of grain in the storage structure.

The best chance that an entrapped person has to escape is to shout to someone outside of the storage structure to shut off the auger. Oftentimes the person in the bin is alone, but even if someone hears the entrapped person shout, it can take some time for the unloading conveyor to be turned off, during which time the person will become further entrapped or even buried as more grain is conveyed from the storage structure. Even if the unloading conveyor is turned off before the person is fully buried in the grain, it is virtually impossible for an entrapped person who is buried up to the waist to free himself or for a rescuer to pull the person free of the grain.

It will be appreciated that if a rescuer attempts to remove grain from around the legs or body of the entrapped person, other grain will immediately flow into the void created by the grain removal. Coffer dams, such as shown in U.S. Pat. No. 9,139,372, are often used by a rescue team to stabilize the grain in which a person is entrapped and to prevent other grain from flowing toward the person as grain from around the person is removed. Once the coffer dam is in place, grain between the entrapped person and the inside of the coffer dam may be removed by the rescue team to free the person. Small portable auger conveyors, such as shown in U.S. Pat. No. 9,139,372, are known that will quickly remove grain from within a coffer dam once the coffer dam is in place so that the entrapped person may be freed from the grain.

In such storage structure rescues, the rescued person or victim is often overly fatigued, injured, incapacitated, or unconscious such that it is difficult for the rescue team to remove the victim from the storage structure. It is common for the rescue team to fit a harness to the victim or to place the victim in a rescue litter so that the victim can be hoisted from the bin through an opening in the bin roof using a retrieval tower and rescue ropes or the like supported by the retrieval tower.

However, existing prior art towers are difficult to use on a sloped storage structure roof that are often sloped at a relatively high slope angle, e.g., up to about 35°. Moreover, many prior art rescue towers must be guy wired or roped to the storage structure to prevent the tower from tipping over as rescue team members are lowered into the storage structure or as the victim is hoisted from within the storage structure. Many storage structures, such as farm grain bins, do not have many, if any, places on their sloped roof to which guy wires or ropes can be readily attached. Also, it is often difficult for a rescue team to lower a victim from the sloped roof to ground level, especially if the victim is incapacitated or is in a rescue litter. Access is often gained to the roof of the storage structure by means of ladders leaning against the storage structure or by a ladder system or circular staircase attached to the sidewall of the storage structure such that it is difficult for a rescue team to get a retrieval tower or other rescue equipment to the roof or to lower a victim or the rescue equipment.

There has been a long-standing need for a retrieval tower that can be readily installed on the sloped roof of a grain bin or other storage structure over an opening (either an existing roof opening or an opening cut in the roof by the rescue team), so that rescue ropes or a powered/hand winch supported by the retrieval tower (or supported by other structure) can be used to hoist the person from within the grain bin. Further, once the rescued person or victim has been removed from the bin and is on the sloped roof, there has been a long-standing need for a system and method that can be readily employed by a rescue team to lower the victim from the sloped roof to ground level.

### SUMMARY OF THE DISCLOSURE

In accord with the present disclosure and as shown in the drawings, a rescue retrieval tower is disclosed that may be readily secured to a sloped roof of a grain bin or other storage structure over an opening in the sloped roof, where rescue ropes or a cable and winch may be supported by the top of the tower over the opening so that rescue ropes or a cable extends down through the opening, which then may be used to lower rescuers into the bin and to hoist the victim and the rescuers from the bin;

The provision of such a retrieval tower that extends above the roof a sufficient distance such that a person, even if unconscious and in a rescue harness or strapped in a rescue litter, may be swung out of the of the tower to be clear of the roof opening;

The provision of such a retrieval tower that may be rapidly clamped to the roof over the opening, and that may be readily removed from the roof;

The provision of such a retrieval tower that can be used on flat roofs and on sloped roofs having a slope angle of up to about 35° or more;

The provision of such a retrieval tower that may be readily adjusted such that the rescue ropes or cable will extend substantially vertically from the top of the tower through the opening with sufficient clearance between the sides of the opening so that a person may readily clear the opening;

The provision of such a retrieval tower that is sufficiently light that a rescue team member may readily carry the tower to the roof of a grain bin or other storage facility using a ladder leaning against the storage structure or carried up a circular staircase affixed to the storage structure;

The provision of such a retrieval tower that may be readily erected and secured (e.g., clamped) to the roof without the use of even simple hand tools and without the need to stabilize the tower with guy wires or the like so long as the top of the tower is substantially over the opening;

The provision of such a retrieval tower that is sufficiently strong so as to support the weight of a heavy adult person, along with any equipment carried or attached to the person being lowered or hoisted into or from the storage structure with an appropriate safety factor to be man-rated;

The provision of such a retrieval tower that may readily be rotated with respect to its base from a first position in which the tower is positioned over a roof opening positioned proximate (e.g., up to about 18 or more inches) from the edge of the roof to a lowering position in which the top of the tower is proximate or extends beyond the edge of the roof so that rescue ropes supported by the top of the tower may be used to lower the person from the roof to ground level; and

The provision of such a retrieval tower that may be used on other storage structures, such as petroleum tanks and the like that need to be periodically inspected or cleaned, where persons entering such storage structures may be overcome by fumes or the like and need to be rescued.

A retrieval tower is disclosed for rescues from a grain bin or other storage structure containing, for example, a supply of fluent granular material, such as grain or the like, that may entrap a person or containing fumes that may incapacitate a person or victim. The storage structure has a sloped roof whose slope ranges between about 0° to about 35°, where the roof has an outer edge (e. g., an eave) and a peak. The tower comprises a base configured to surround an opening in the roof of such storage structure, where the base has a pair of side rails adapted to be disposed on opposite sides of the opening and extending substantially along the slope of the roof and a pair of cross members extending between the ends of the side rails proximate the upper and lower margins of the opening. At least one clamp member is adapted to be inserted into the opening and to be positioned under a respective the cross member with a portion of the roof proximate the opening therebetween. The clamp member has a clamp adapted to clamp a portion of the roof between the clamp member and its respective cross member so as to securely mount the base to the roof. A pair of spaced legs (e.g., front legs) is adapted to be attached to one of the cross members, preferably attached to the cross member toward the edge of the roof. A head is supported by the upper ends of the spaced legs, at least one other leg (e.g., a back leg) is pivotally attached to the head and extends downwardly and is adapted to be attached to the other of the cross members. The other or back leg includes means for adjusting the length of the back leg.

A method of effecting a rescue of a victim from within a storage structure, such as a grain bin, is described in which the victim has become entrapped in grain or the like, or has otherwise been overcome in the storage structure, where the storage structure has a roof whose slope ranges between about 0° to about 35°, and were the roof has an outer edge or eave. This method uses a retrieval tower comprising a base configured to surround an opening in the roof of such storage structure. The base has a pair of side rails adapted to be disposed on opposite sides of the opening and a pair of cross members configured to extend between the end portions of the side rails and to be disposed proximate the opening. At least one clamp member adapted to be inserted into the opening and to be positioned under a respective cross member with a portion of the roof proximate the opening therebetween. The clamp member has a clamp for clamping a portion of the roof between the clamp member and its respective cross member so as to securely mount the base to the roof. The tower further comprises a pair of spaced legs attached to one of the cross members, preferable attached to the cross member toward the edge of the roof. A head is supported by the upper ends of the front legs. The tower comprises at least one other leg (e.g., a back leg) attached to the head that extends downwardly to be attached to the other of the cross members. The method of the present disclosure comprises positioning the base on the roof surrounding the opening with the side rails extending generally perpendicular to the edge of the roof and extending along the slope of the roof with the cross members being positioned to extend between the side rails. At least one of the clamping members is installed on the inside of the roof substantially under a respective cross member with a portion of the roof proximate the opening disposed therebetween. The clamp member and its respective cross member are clamped to the roof such that the portion of the roof between the clamp member and the cross member is securely clamped so as to secure the base to the roof. The pair of legs is secured to one of the cross members, preferably the cross member toward the roof edge, such that the pair of legs constitute the front legs of the tower. The other leg constituting the rear leg of the tower is attached to the other of the cross members with the head positioned substantially over the opening so that rescue ropes or a cable from a winch attached to the tower or other suitable structure is supported by the head will pass through the opening thus allowing rescuers to be lowered into the storage structure and to enable the victim to be hoisted from within the storage structure.

Other objects and features of this disclosure will be in part described herein and will be apparent to one of ordinary skill in the art.

### BRIEF DESCRIPTION OF THE DRAWINGS

FIG. 1 is a perspective view of a retrieval tower of the present disclosure as it is installed in a first position on a sloped roof of a storage structure, such as a grain bin or the like, over an opening in the roof through which a person may be lowered into the storage structure or hoisted therefrom;

FIG. 2 is a side elevational view of the retrieval tower on a somewhat smaller scale than FIG. 1 as it is installed in a first position on the sloped roof over the opening;

FIG. 3 is a front elevational view of the retrieval tower;

FIG. 4 is a top plan view of the retrieval tower;

FIG. 5 is an enlarged perspective view of a portion of the tower, taken along circular line 5-5, as shown in FIG. 1, illustrating a clamp member that may be readily installed on the inside of the roof and operated to clamp the tower to the roof proximate the opening; and

FIG. 6 is a side elevational view of the tower in a second position such that the top of the tower extends out beyond the edge of the sloped roof of the grain bin so that the tower can be used with appropriate rescue ropes or cables connected to a winch to lower a person (e.g., the victim) from the roof to ground level.

Corresponding reference characters represent corresponding parts throughout the several views of the drawings.

### DESCRIPTION OF A PREFERRED EMBODIMENT

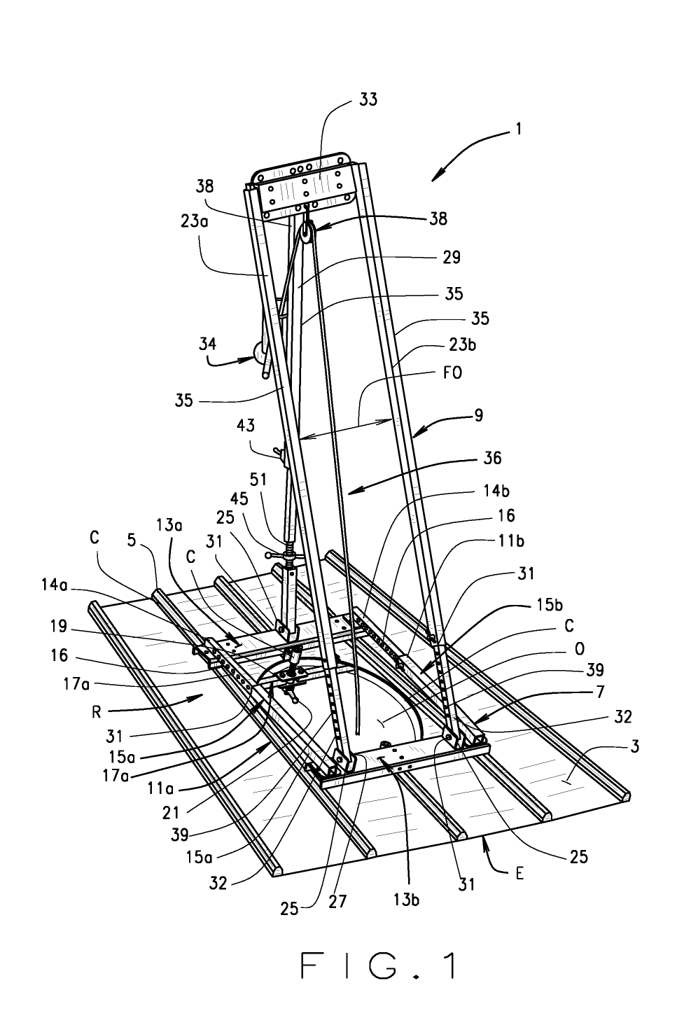

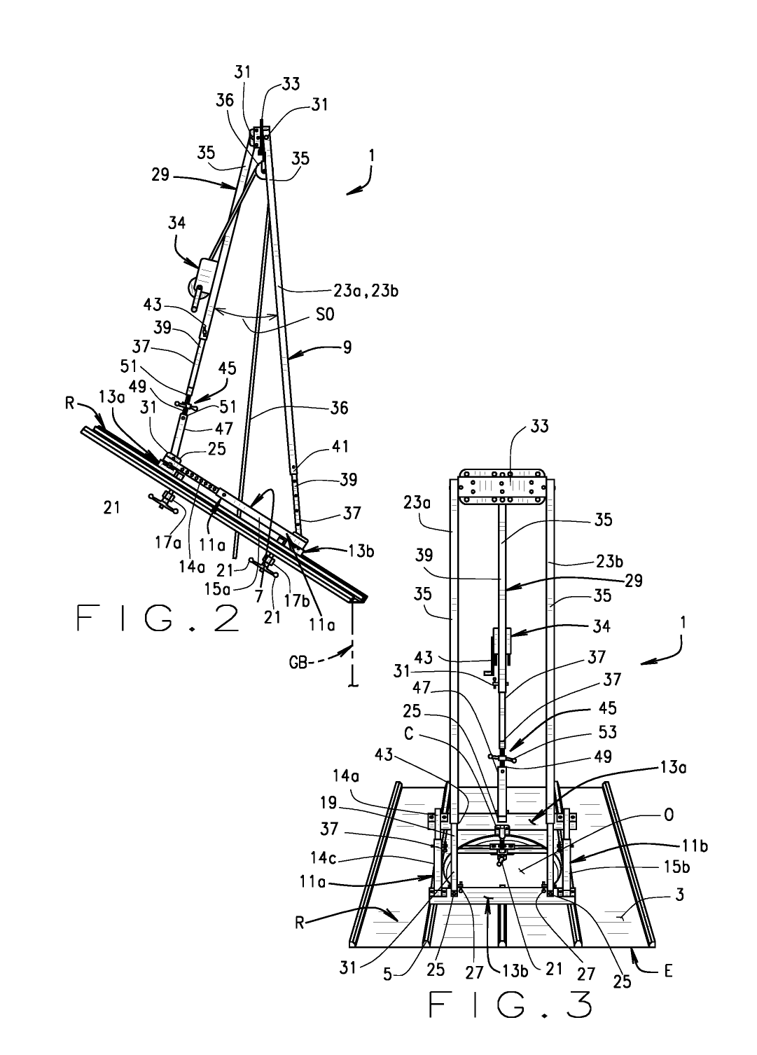

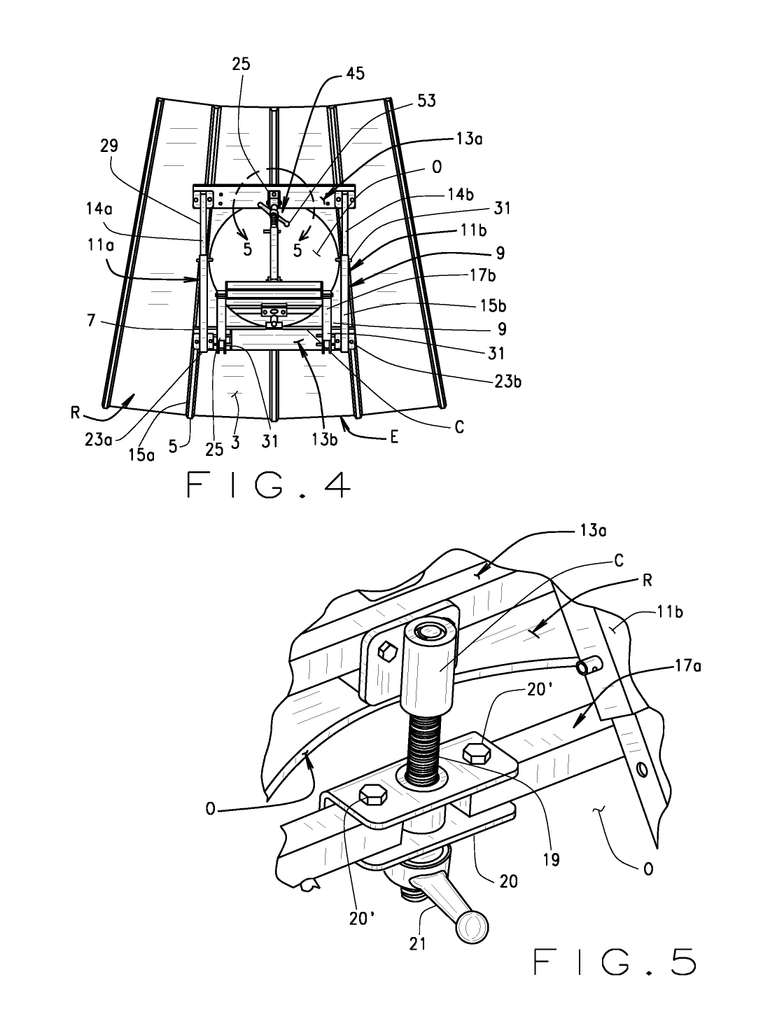

Referring now to the drawings, a retrieval tower, in accord with a preferred embodiment of the present disclosure, is generally indicated at 1 and is shown in FIGS. 1-5 installed in a first position on a sloped roof R of a grain bin GB (as shown in phantom in FIG. 2) or other storage structure over an opening O in the roof R. Typically, the roof of a grain bin is a sloped roof having a slope angle (as best shown in FIG. 2) ranging between about 0° up to about 35°, or somewhat more, but in some instances the roof of a storage structure may be flat having little or no slope.

Grain bin roofs are generally conical-shaped and typically are comprised of a series of pie-shaped triangular roof panels 3 extending upwardly from the outer edge or eave E of the roof to a center ring (not shown) at the apex or peak of the roof. The roof panels 3 have raised seams or ribs 5 that that extend from the roof edge to the peak of the roof and are sealed to keep rain out of the bin. Conventionally, the roof panels 3 are made of sheet metal and the seams or ribs 5 strengthen the roof such that personnel can walk on the roof. The opening O may be an existing opening in the roof that is provided for access to the interior of the bin, or it may be an emergency hole cut in the roof by rescue personnel. In many commercially available grain bins, the opening O may be a man hole or access portal that is typically spaced 12-18 inches from the roof eave E so that a farmer or other bin personnel may access the opening from a ladder or a staircase affixed to the side wall of the storage structure. The opening is typically reinforced by a collar or coaming C (as shown in FIG. 1) having a lid (not shown) that closes the opening. In certain rescue instances, it may be necessary for rescue personnel to cut an opening in the roof R to access a person to be rescued. Preferably, the opening O is of sufficient size (e.g., 24-36 inches) so as to allow a person supported by rescue ropes or cable attached to tower 1 to be lowered into or hoisted from the bin through the opening. The opening may be round, oval, or rectangular shaped.

Retrieval tower 1 comprises a base 7 that is adapted to be removably clamped or otherwise secured to the roof so as to surround opening O and a raised tower 9 secured to the base. More specifically, base 7 comprises a pair of spaced side rails 11a, 11b configured to extend generally parallel to the roof ribs 5 and to be spaced outside of opening O when the tower is installed on the roof R. The base further comprises a pair of spaced cross members 13a, 13b adapted to be removably secured to the end portions of side rails 11a, 11b by quick release pins 31 (as will be described hereinafter). The side rails are preferably spaced apart somewhat wider than the diameter or width of opening O, and the cross members are preferably spaced in close proximity above the upper and lower edges of the opening. The side rails and the cross members are somewhat longer than the diameter of the opening so as to give rescuers full access to the opening. Each of the side rails 11a, 11b has a respective extension 14a, 14b that is telescopically received in a respective main portion 15a, 15b of each side rail so that the length of the side rails may be adjusted to fit the size of opening O. As shown best in FIG. 1, each of the extensions 14a, 14b has a series of spaced holes 16 therealong at, for example, two inch intervals. When the side rails are adjusted for the size of the opening, the extensions 14a, 14b can be fixed in place to their respective main portion 15a, 15b by a quick release pin 31. As would be apparent to one skilled in the art, the length of the cross members 13a, 13b may also be adjustable to accommodate openings O of different sizes, but as described herein, the length of cross members 13a, 13b is not adjustable, instead they are of sufficient length to accommodate openings of various widths.

As shown best in FIG. 5, each cross member 13a, 13b has an internally threaded collar C affixed to the center of the cross member with the collar C being positioned to be just inside of opening O when the cross member is installed on a roof R. A foldable or hinged clamp bar 17a or 17b is configured to be positioned on the inside of the roof R somewhat inside of the edge of the opening just below its respective cross member 13a or 13b. Once positioned inside of opening O, each clamp bar may be unfolded to be positioned on the underside of the roof just below a respective cross member. As best shown in FIG. 5, a clamp screw 19 is threadably carried by a clamp bracket 20 that is hingedly secured to its respective clamp bar 17a or 17b by hinge pins 20′. Clamp bracket 20 threadably carries clamp screw 19 that is configured to be threadably received in its respective collar C attached to its respective cross member 13a, 13b. Each clamp screw 19 has a handle 21 so that a rescue worker can readily turn the screw for clamping or unclamping the base 7 to the roof R. When the base 7 is positioned around opening O, as a shown in the drawings, and when a clamp bar 17a or 17b is unfolded on the inside of the roof, its respective clamp screw 19 may be readily threaded into its collar C. Upon further tightening clamp screws 19, a portion of the roof panel 3 proximate opening O is forcefully clamped between the cross-members 13a, 13b and the clamp bars 17a, 17b to securely clamp base 7 to the roof R. Cross members 13a, 13b may be channel-shaped members having their flanges facing the roof so that when they are forcefully clamped to the roof by their respective clamp members 17a, 17b, the edges of the channel flanges forcefully grip the sheet metal ribs 5 of the roof panels 3 so as to firmly hold base 7 in place on the roof without slippage. While two of the clamp bars 17a, 17b are shown and are preferred, it will be understood that one such clamp bar may be sufficient to securely clamp the retrieval tower 1 in place on roof R. It will be further appreciated that because clamp bars 17a, 17b are, preferably but not necessarily, foldable so that when they are in their folded position, the clamp bars may be readily inserted into the opening O and then unfolded to the position shown in the drawings, so as to be positioned below their respective cross member 13a or 13b. Likewise, upon removal of tower 1 from the roof, the screws 19 may be unscrewed from their respective collars C so as unclamp the base from the roof. The clamp bars may then be folded to facilitate their removal from opening O.

With base 7 firmly clamped in place on roof R around opening O, as above described, tower 9 may be installed on the base. The tower 9 is preferably, but not necessarily, a three legged unit having a pair of spaced front legs 23a, 23b configured to be removably and pivotally secured to the lower cross member 13b. More specifically, the lower end of each of the front legs is received in a clevis fitting 25 secured on the upper surface of the lower cross member 13b and is pivotally attached to the clevis fittings by a quick release pin 31. The tower preferably has a single back leg 29 secured to its cross-member 13a. However, in certain instances, two spaced back legs 29 may be desirable. The lower end of back leg 29 is preferably received in a clevis 25 secured to the upper cross-member 13a by means of a quick release pin 31. The upper end of back leg 29 is pivotally connected by another pin 31 to an upper head member 33 which is carried on the upper ends of front legs 23a, 23b.

In accord with the present disclosure, upper head 33 may be used to attach different rescue roping systems to the tower, where such roping systems are well known to those skilled in the rescue field. With such roping systems attached to head 33, when the head is positioned over opening O rescue personnel and rescue equipment may be lowered into or raised from the storage structure and a victim may be hoisted from within the storage structure. Preferably, head 33 is pivotally connected to the upper ends of front legs 23a, 23b so that upon the head supporting a load on a rescue rope or cable supported by the head, the head will pivot to be in line with the load on a rescue rope attached to the head. Additionally, a winch and cable (or rope) assembly, as generally indicated at 34, may be mounted to one of the legs (e.g., leg 29, as shown in the drawings) such that a cable or rope 36 (or other flexible tension member) extending from the winch may be entrained through a suitable pulley 38 attached to the head and will extend downwardly opening O preferably near the center of the opening such that the rope may be used to lower and raise rescue personnel and equipment into and out of the storage structure and to hoist a victim from within the storage structure. The winch may either be manually operated by a hand crank winch, or it may be powered by an electric motor. One such winch that is commercially available is from Pelsue of Englewood, Colo. As shown, a single pulley 38 is attached to head 33 and the rope or cable 36 is passed around this pulley. However, as those skilled in the art will know, that instead of a simple pulley, a block and tackle system may also be used. Quick release pins 31, as described in this disclosure, are preferably used to secure lock side rails 11a, 11b at their desired length, to secure tower 9 to base 7 and to lock the leg extensions to the main portions of the front legs 23a, 23b and back leg 29. These quick release pins are also known as ball lock pins and are commercially available from Carr Lane Mfg. Co., of St. Louis, Mo. Such pins may be attached to surrounding structure by a cable lanyard (not shown) so that they are not separated from the legs when disengaged to prevent them from being lost during use or storage of tower 1. Further, it is preferable that base 7 and tower 9 are made of a suitable aluminum alloy to minimize the weight of those components thus making it easier for rescue personnel to carry or hoist the rescue tower to the roof of a storage structure.

As previously mentioned, roof R is typically a sloped roof having a slope angle ranging between about 0° and about 35° or more. In order to accommodate roofs of different slopes, including flat roofs, and to insure that a rescue rope or a cable 36 supported by head 33 is appropriately positioned within the opening O, the lower portions of the front tower legs 23a, 23b and the back tower leg 29 may preferably be lengthened or shorted so that when the tower 9 is in its first position, head 33 is substantially directly above opening O. However, it is not necessary (only preferable) that the length of the front legs be adjustable. As shown in the drawings, the upper or main portion 35 of each front leg 23a, 23b and of back leg 29 is a hollow tube. The lower portion of each leg is an extension 37 having a somewhat smaller cross section than the opening in hollow tube forming the main portion 35 such that the extensions are telescopically received in their respective main portions 35. Each of the extensions 37 has a series of spaced holes 39 therein spaced at, for example, two inch increments (as best shown in FIG. 2), such that when one of these spaced holes is in register with a hole 41 in the lower end of the main portions 35 of legs 23a, 23b or 29, a quick release pin 31 may be inserted so as to fix the length of the length of the extensions 37 extending from the bottom of the upper portions of the tower legs. In this manner, the length of the legs may be rapidly adjusted and fixed in increments.

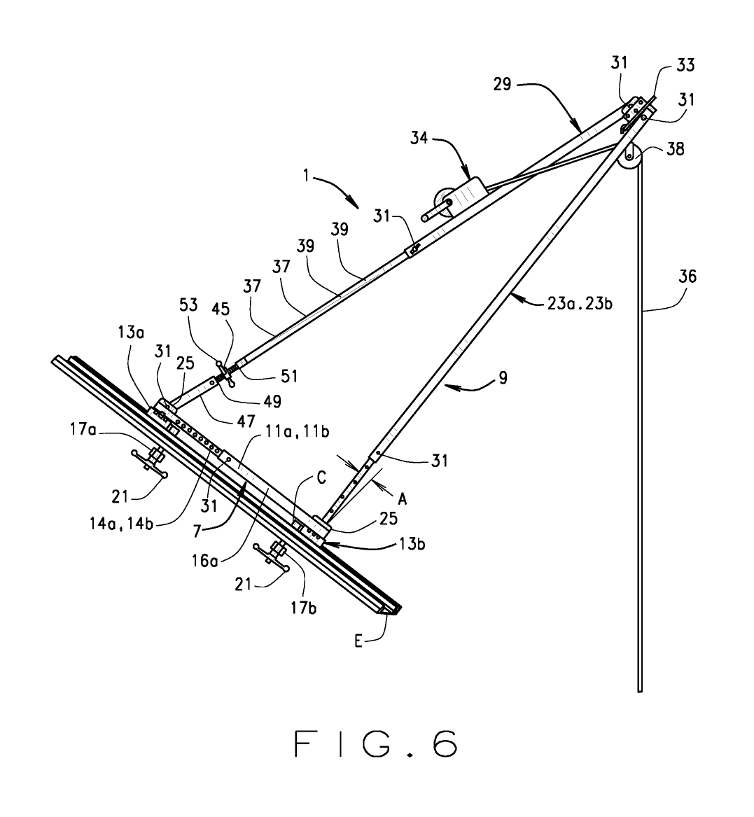

While shortening or lengthening of back leg 29 may be accomplished by pulling its quick release pin 31 and extending or retracting its extension 37 according to the spacing of holes 39 and then re-inserting the pin, it is preferred that a screw jack arrangement, as generally indicated at 45, be utilized so that the length of the back leg may be adjusted without disconnecting the back leg from base 7. Screw jack 45 includes a first screw collar 47 pivotally mounted by a quick release pin 31 received in a clevis 25 that is secured to the center of upper cross member 13a. Screw jack 45 has a lower screw portion 49, which is threadably received in base collar 47, and an upper screw portion 51, which is threadably received in a second screw collar (not shown) housed within the lower end of leg extension 37 of back leg 29. The screw threads on the lower and upper screw portions 49 and 51 of screw jack 45 are threaded opposite one another (i.e., one portion has right-hand threads and the other has left-hand threads) so that upon turning the screw jack in one direction or the other by means of a handle 53, the length of back leg 29 may be adjustably extended or shortened. It will be appreciated that screw jack 45 is constructed such that the screw portions 49 and 51 cannot be fully unscrewed from their respective screw collars thus preventing the screw jack from becoming uncoupled from base collar 47 and from leg 29 so that the back leg 29 is connected to its cross member 13a at all times as the length of the back leg is adjusted. More particularly, a screw stop (not shown), such as a stop pin carried by one of the screw portions, will prevent the one screw portion from being fully unthreaded from its respective screw collar. Also, the other screw portion is preferably somewhat longer that the other such that when the one screw portion with the stop pin comes against its stop, the other screw portion is fully threadably engaged with its respective screw collar. It will also be appreciated that the screw jack 45 may be used to more finely adjust the length of back leg 29 to adjust the position of a rescue rope 36 as it extends through opening O or as it extends beyond eave E, as best shown in FIG. 6.

The height of tower 9 and the slope of roof R may be such that when tower 1 is spaced appropriately close (e.g., within about 10-12 inches) to roof edge E, screw jack 45 has sufficient extension (up to about 24 inches) such that the tower may be repositioned from its first position (as shown in FIGS. 1-5) in which head 33 is positioned over opening O to its second position (as shown in FIG. 6) in which the head is positioned out beyond roof edge E. As shown in FIG. 6, when in its second portion, the front legs 23a, 23b of tower 9 are not quite perpendicular to side rails 11a, 11b, as shown by angle A. However, it will be understood that when tower 9 is in its second position, the front legs may be angled beyond perpendicular to side rails 11a, 11b so that head 33 is positioned at or the beyond the plane of roof edge E. In such cases, it is advised that the tower 1 be stabilized relative to the roof R by means of appropriate guy ropes or cables (not shown) attached to the roof R in a manner will-known to trained rescue personnel. By lengthening back leg 29 from its length, as shown in FIG. 2, to its length, as shown in FIG. 6, so that the tower is in its second position, a rescue rope attached to head 33 will be positioned to pass vertically outwardly beyond the eave E of the roof so that loads may be hoisted from ground level to the roof, and, a victim, may lowered from the roof to ground level.

As mentioned above, screw jack 45 is preferably used to move tower 9 from its first position to its second position so that back leg 29 remains securely attached to its cross member 13a. However, in other instances, particularly where the opening O is farther from the roof edge E or where the slope of the roof is low, screw jack 45 may not have sufficient adjustment capability to fully move the tower to its second position. In those instances, it may be necessary to remove the load supported by head 33 and to pull the quick release pin 31 coupling extension 37 from the main portion 35 of the back leg 29 to lengthen the back leg and to re-insert the pin to lock the back leg in this lengthened position. Then, the screw jack may be used for final positioning of the tower in its second position.

In a rescue attempt of a person entrapped in grain (or in other granular fluent material, such as plastic pellets) inside of a grain bin GB or overcome by fumes or the like in another storage structure, rescue personnel may, upon arrival at the grain bin, quickly install the retrieval tower 1 of the present disclosure to the roof R of the grain bin over an opening O in the roof. The opening may be one that has been provided in the roof for ingress and egress into and out of the bin for normal inspection and maintenance purposes, or the opening may be one that is rapidly cut in the roof by rescue personnel using a rotary abrasive saw or the like. The base 7 and the tower 9 may be readily carried or hoisted by rescue personnel from ground level to the roof. Once the rescue personnel arrive at the location of opening O, the base 7 is assembled and positioned on the exterior of the roof R to surround the opening with the side rails 11a, 11b on opposite sides of the opening and with cross members 13a, 13b positioned proximate the upper and lower edges of the opening and connected to the side rails. Rescue personnel may then insert a folded clamp bar 17a or 17b through opening O, unfold the clamp bar, and position the clamp bars below their respective upper or lower cross member 13a, 13b on the inside of the bin roof. Then, clamp screw 19 is aligned with its screw collar C, and handle 21 is manually turned to securely clamp the base 7 to the roof. With the base clamped in place on the roof, rescue personnel may then install tower 9 to the base 7 by inserting quick release pins 31 through clevises 25 on the lower cross member 13b and through holes a hole in the bottom of leg extension 37 to attach front legs 23a, 23b to cross member 13b. Back leg 29 may then be attached to its clevis 25 on the upper face of the upper cross member 13a by a quick release pin 31 in a similar manner. Legs 23a, 23b and 29 may be lengthened or shortened, as above described, so that with the tower 9 is in its first position, a rescue rope 36 or cable will extend vertically downwardly from head 33 through opening O. It will be appreciated that the legs 23a, 23b and 29 are of sufficient length that side openings SO are formed between one of the lower side legs 23a, 23b and the upper leg 29 of tower 9 of sufficient size to allow a person wearing a safety harness or the like and connected to a rescue rope attached to head 33 via pulley 38 to step through one of the side openings SO (as best shown in FIG. 2) in the tower to be lowered into the opening O. In this manner, the rescue rope or cable 36 will support the weight of the rescuer as the rescuer is lowered into the bin or hoisted from the bin. Side openings SO are also of sufficient size that a victim, even when strapped in a rescue litter, may be hoisted from within the bin and may be maneuvered sideways from the tower to be clear of the opening O. Still further, the front legs 23a, 23b are preferably spaced apart a sufficient distance to from a front opening FO (as best shown in FIG. 1) of sufficient size to allow personnel to enter or exit the opening between the front legs and to allow a victim in a litter to be removed from the tower. If a pair of spaced rear legs 29 is used, there will be a corresponding back opening (not shown in the drawings) between the spaced back legs. Of course, once rescue operations are complete, the retrieval tower 1 may be readily removed from the grain bin roof.

As various changes could be made to the above constructions and embodiments without departing from the broad scope of this disclosure, it is intended that all matter contained in the above description or shown in the accompanying drawings be interpreted in as illustrative and not in a limiting sense.

What is claimed:

1. A retrieval tower for rescues from a grain bin or other storage structure containing, for example a supply of fluent granular material that may entrap a person or fumes that may incapacitate a person, said storage structure having a roof whose slope ranges between about 0° to about 35°, where said roof has an outer edge and a peak, said tower comprising a base configured to surround an opening in the roof of said storage structure, said base having a pair of side rails adapted to be disposed on opposite sides of said opening and a pair of cross members extending between said side rails and adapted to be disposed proximate the upper and lower portions of said opening, at least one clamp member adapted to be inserted into said opening and to be positioned under a respective one of said cross members with a portion of the roof proximate said opening therebetween, said clamp member having a clamp for clamping said portion of said roof between said clamp member and its respective cross member so as to securely mount said base to said roof, a pair of spaced legs attached to one of said cross members, a head supported by the upper ends of said pair of legs, at least one other leg pivotally attached to said head and extending down and attached to the other of said cross members, and means for adjusting the length of said other leg to effect movement of said tower from a first position in which a rescue rope or cable attached to said support passes substantially vertically through said opening to a second position in which said support is positioned proximate to or beyond said roof edge so that a victim supported by a rescue rope or cable attached to said support may be lowered from said roof to ground level.

2. A retrieval tower as set forth in claim 1 wherein the length of said side rails is adjustable to accommodate different size and shapes of said opening in said roof.

3. A retrieval tower as set forth in claim 1 wherein said clamp carried by said clamp member is a clamp screw threadably carried by said clamp member and being adapted to be received in a threaded collar carried by its respective cross member positioned to be inside of said opening so that upon tightening of said clamp screw said portion of said roof between said cross member and said clamp member is firmly clamped.

4. A retrieval tower as set forth in claim 3 wherein said head is adapted to mount one or more rescue ropes and/or a cable and winch.

5. A retrieval tower as set forth in claim 1 wherein said pair of legs is connected to a said cross member proximate said roof edge and constitute front legs, wherein said other leg constitutes a back leg.

6. A retrieval tower as set forth in claim 5 wherein the length of said front and rear legs is adjustable.

7. A retrieval tower as set forth in claim 6 wherein each of said front legs has a tubular main portion and an extension telescopically received in its main portion, said extension having a plurality of spaced holes therealong and where said main portion is adapted to receive a pin or the like that engages a selected one of said spaced holes in said extension for locking said extension relative to said main portion thereby to fix the length of said front legs.

8. A retrieval tower as set forth in claim 7 wherein said means for adjusting the length of said other or back leg comprises a screw jack for varying the length of said back leg, said screw jack comprising a first threaded receiver pivotally secured to said cross other member and a second threaded receiver carried by said main portion of said back leg, a screw having a first set of threads that threadably engages the first threaded receiver and a second set of screw threads that threadably engages said second threaded receiver, the threads of one of said sets of threads being right-hand threads and the threads of the other of said set of threads being left-hand threads such that when said screw is rotated, said screw jack will lengthen or shorten said back leg without having to uncouple said back leg from its respective said cross member.

9. A retrieval member as set forth in claim 8 wherein with said tower positioned in said first position, said tower may be readily changed to said second position by lengthening said back leg.

10. A retrieval tower as set forth in claim 9 wherein said screw jack may be employed to lengthen said rear leg to move said tower from said first position to said second position without having to disconnect said rear leg from said other cross member.

11. A retrieval tower as set forth in claim 9 wherein said back leg has a tubular main portion and an extension telescopically received in said main portion and extending therefrom, said extension having a series of spaced holes therealong for receiving a pin carried by the lower end of said main portion thereby to fix said extension at a desired position relative to said main portion, the lower end of said extension housing said threaded receiver carried by said main portion of said main portion of said back leg, said screw jack being disposed between extension and said threaded receiver coupled to said cross member.

12. A retrieval tower as set forth in claim 1 further comprising a winch adapted to be secured to one of said legs, said winch having a flexible tension member, such as a rope or cable, extending from said winch and passing through a pulley supported from said head and extending through said opening vertically downwardly into said storage structure for lowering rescue personnel into said storage structure and/or to hoist such personnel or a victim from within the storage structure.

13. A method of effecting a rescue of a victim from within a storage structure in which a victim has become entrapped in a fluent, granular material such as grain or has otherwise been overcome or incapacitated, using a retrieval tower, said storage structure having a sloped roof whose slope ranges between about 0° to about 35°, said roof having an outer edge, said rescue tower comprising a base configured to surround an opening in the roof of such storage structure, said base having a pair of side rails adapted to be disposed on opposite sides of said opening and a pair of cross members extending between said side rails and disposed proximate the top and bottom of said opening, at least one clamp member adapted to be inserted into said opening and to be positioned under one of said cross members with a portion of the roof proximate said opening therebetween, said clamp member having a clamp for clamping said portion of said roof between said clamp member and said one cross member so as to securely mount said base to said roof, said rescue tower further comprising a tower having a pair of front legs spaced from one another and attached to one of said cross members proximate the edge of said roof, a head supported by the upper ends of said front legs, and at least one back leg attached to said head and extending down and attached to the other of said cross members, said method comprising the steps of:
a. Positioning said base on said roof surrounding said opening with said side rails extending generally perpendicular to the edge of said roof on opposite sides of said opening and with said cross members extending between said side rails;
b. Installing said at least one clamping member through said opening on the inside of said roof substantially under a respective cross member;
c. Clamping said clamp member and said respective cross member to said roof so as to secure said tower to said roof;
d. Attaching said pair of front legs to one of said cross members toward said roof edge and attaching said back leg to the other of said cross members with said tower being positioned in a first position in which said head is positioned substantially over said opening so that a rescue rope or a cable attached to said head will pass through said opening thus enabling rescuers to be lowered into said storage structure and enabling said victim to be hoisted from within said storage structure.

14. The method of claim 13 wherein said front and rear legs of said tower may be lengthened or shortened, and wherein said method further comprises repositioning said tower in a second position in which said head is located substantially over or beyond the edge of the roof so that said victim may be lowered to the ground from the roof using ropes or a cable supported by said head of said tower.

15. The method of claim 14 wherein in order to so reposition said tower, said back leg is lengthened.

16. The method of claim 15 wherein said rear leg has a screw jack incorporated therein, and wherein said method comprises the step of lengthening or shortening said rear leg via said screw jack without disconnecting said rear leg from its respective said cross member.
